(19) United States
(12) Patent Application Publication
(10) Pub. No.: US 2014/0215071 A1
(43) Pub. Date: Jul. 31, 2014

(54) METHOD AND DEVICE FOR RECEIVING CONTENT

(71) Applicants: Minsoo Lee, Seoul (KR); Seungryul Yang, Seoul (KR); Changhyun Oe, Seoul (KR)

(72) Inventors: Minsoo Lee, Seoul (KR); Seungryul Yang, Seoul (KR); Changhyun Oe, Seoul (KR)

(73) Assignee: LG ELECTRONICS INC., Seoul (KR)

(21) Appl. No.: 14/239,089

(22) PCT Filed: Jun. 13, 2012
(86) PCT No.: PCT/KR2012/004649

§ 371 Date: Feb. 14, 2014

Related U.S. Application Data
(60) Provisional application No. 61/524,775, filed on Aug. 18, 2011.

(51) Int. Cl. H04L 12/865

(52) U.S. Cl. CPC H04L 47/6275
USPC 709/225

(57) ABSTRACT

Disclosed are a method and device for receiving content. The method for receiving content is performed by a client device, acquires a plurality of source access information by searching a plurality of sources storing selected content, generating at least one q request including a plurality of source access information, selecting one of source access information among a plurality of source access information based on at least one q request, and receives the selected content by using the selected source access information. Therefore, the content can be received by selecting a content source, which is effectively transmitting the content, or the content source based on the invention of a user among a plurality of content sources.

### TECHNICAL FIELD

The present invention relates to a method and apparatus for receiving content and, more particularly, to technology capable of selectively receiving content from a plurality of content sources which can send content.

### BACKGROUND ART

Recently, as data communication standards and the standardization of a terminal are carried out and devices become intelligent, a need of constructing a more efficient and convenient system by associating a plurality of devices and services with each other is increased. A representative example that complies with such a need is a home network. A home network associates devices and services that are distributed at several places, such as information home appliances, wireless communication devices, and Personal Computer (PC)-related devices, with each other through wired or wireless communication based on various standards, such as Digital Living Network Alliance (DLNA) and Universal Plug and Play (UPnP).

Such a home network can provide a content sharing environment in which content can be transmitted and shared between devices. For example, media content stored in a specific device within a local network can be transmitted to another device of the local network, and a device that has received the media content can store the received media content and play back the stored media content in response to a request from a user.

Typically, a DLNA or UPnP device downloads or streams content from a Digital Media Server (DMS) within a home in which content is stored. Here, downloading or streaming speed of the content may be changed depending on various factors, such as the processing performance of a transmission or reception device, a network state, and an unexpected error.

Accordingly, when downloading or streaming content, if a communication state between a transmission device that sends the content and a reception device that receives the content is not good, the time taken to send the content becomes long or it is difficult to send the content. In such a case, an interruption phenomenon occurs when the reception device plays back the content or a problem, such as that the playback of content is made impossible, may occur due to delay in the downloading or streaming of the content.

### DISCLOSURE

### Technical Problem

The present invention has been made to solve the problems, and an object of the present invention is to provide a method and apparatus for receiving content, which are capable of receiving content by selecting at least one of a plurality of content sources.

### Technical Solution

In order to accomplish the object, an aspect of the present invention provides a method for receiving content. The method for receiving content is performed by a client device and includes acquiring a plurality of source access information by searching a plurality of sources storing selected content; generating at least one queue request including the plurality of source access information; selecting any one of source access information among the plurality of source access information based on at least one queue request; and receiving the selected content by using the selected source access information.

The at least one queue request may include a first queue request including first source access information and second source access information. The selecting of any one of source access information among the plurality of source access information may include selecting any one of the first source access information and the second source access information, based on any one of transmission bandwidth information corresponding to each piece of source access information and a selection signal input from a user interface.

The method for receiving content may further include transmitting, to a first source and a second source, a content download request of requesting to transmit the content by using the first source access information and the second access information; downloading the content from the first source and the second source for a predetermined time, respectively, and estimating a transmission bandwidth corresponding to each of the first source access information and the second source access information, by analyzing the content download for the predetermined time.

The selecting of any one of source access information among the plurality of source access information may include selecting source access information having a larger transmission bandwidth, based on transmission bandwidth information corresponding to the first source access information and transmission bandwidth information corresponding to the second source access information.

The at least one queue request may include a first queue request including the first source access information and a first queue request priority and a second queue request including the second source access information and a second queue request priority. The method for receiving content may further include setting the first queue request priority and the second queue request priority, based on any one of the transmission bandwidth information corresponding to each piece of source access information and priority information input from a user interface.

The method for receiving content may further include transmitting a content download request of requesting to transmit the content to a first source and a second source by using the first source access information and the second access information; downloading the content from the first source and the second source for a predetermined time, respectively; estimating a transmission bandwidth corresponding to each of the first source access information and the second source access information, by analyzing the content download for the predetermined time; and setting the first queue request priority and the second queue request priority according to the transmission bandwidth corresponding to the first source access information and the transmission bandwidth corresponding to the second source access information.

The selecting of any one of source access information among the plurality of source access information may include transiting a queue request having a high priority of the first queue request and the second queue request to an active status and transiting a queue request having a low priority of the first queue request and the second queue request to any one of a blocked state, a standby state, and a suspended state. The method for receiving content may further include using the source access information included in the queue request transited to the active state, in order to download the selected content.

The plurality of source access information may include at least any one of a Universal Resource Identifier (URI) for accessing the content stored in a device of a user domain and a universal resource identifier for accessing to the content stored in a device of a server domain.

Meanwhile, in order to accomplish the object of the present invention, in another aspect, the present invention provides an apparatus for receiving content. The apparatus for receiving content may include an application configured to acquire a plurality of source access information by searching a plurality of sources storing a selected content and generate at least one queue request including the plurality of source access information and a queue and policy engine configured to select one source access information among the plurality of source access information based on at least one queue request and receive the selected content by using the selected source access information.

The at least one queue request may include a first queue request including first source access information and second source access information.

The queue and policy engine may select any one of the first source access information and the second source access information, based on any one of transmission bandwidth information corresponding to each piece of source access information and a selection signal input from a user interface.

The at least one queue request may include a first queue request including the source access information and a first queue request priority and a second queue request including the second source access information and a second queue request priority.

The application may set the first queue request priority and the second queue request priority, based on any one of the transmission bandwidth information corresponding to each source access information and priority information input from a user interface. The queue and policy engine may transit a queue request having a high priority of the first queue request and the second queue request to an active status, and transits a queue request having a low priority of the first queue request and the second queue request to any one of a blocked state, a standby state, and a suspended state.

### Advantageous Effects

As described above, in accordance with the present invention, a content source capable of effectively sending content or a content source based on a user's intention can be selected from a plurality of content sources, and content can be received through the selected content source. Accordingly, interruption or the stoppage of playback when playing back content can be prevented and service satisfaction can be improved by solving delay in the downloading or streaming of content or selecting a content source based on a user's intention.

### DESCRIPTION OF DRAWINGS

FIG. 1 is a block diagram showing the construction of a content service system to which a method for receiving content according to a preferred embodiment of the present invention can be applied.

FIG. 2 is a block diagram illustrating a detailed structure of the client device of the content service system and related interfaces.

FIG. 3 is a table illustrating the interfaces shown in FIG. 2.

FIG. 4 is a block diagram illustrating the interoperation of devices related to the method for receiving content according to a preferred embodiment.

FIG. 5 is a flowchart illustrating the method for receiving content according to a preferred embodiment of the present invention.

FIG. 6 is a flowchart illustrating a method for receiving content according to another preferred embodiment of the present invention.

FIG. 7 is a flowchart illustrating a method for receiving content according to yet another preferred embodiment of the present invention.

FIG. 8 is a flowchart illustrating a method for receiving content according to yet another preferred embodiment of the present invention.

FIG. 9 shows a diagram for illustrating the life cycle of a queue request and a change of the state.

FIG. 10 shows a table illustrating device capability items.

FIG. 11 is a table illustrating content information managed and provided by a content source.

FIG. 12 is a table showing content selection information stored and managed by a client device.

### MODE FOR INVENTION

The present invention may be modified in various ways and may have several embodiments, and specific embodiments are to be illustrated in the drawings and described in detail. It is however not intended to limit the present invention to a specific embodiment, and it should be understood that the embodiment includes all changes, equivalents, and substitutions that are included in the spirit and technical scope of the present invention.

Terms, such as the first and the second, may be used to describe a variety of elements, but the elements should not be limited by the terms. The terms are used to only distinguish one element from the other element. For example, a first element may be named a second element, and likewise a second element may be named a first element without departing from the scope of the present invention. A term ‘and/or’ includes a combination of a plurality of related and described items or any one of a plurality of related and described items.

When it is said that one element is described as being ‘connected’ to or ‘coupled’ with the other element, the one element may be directly connected to or coupled with the other element, but it should be understood that a third element may be interposed between the two elements. In contrast, when it is said that one element is described as being ‘directly connected’ to or ‘directly coupled’ with the other element, it should be understood that a third element is not present between the two elements.

Terms used in this application are used to describe only specific embodiments and are not intended to limit the present invention. An expression of the singular number should be understood to include plural expressions, unless clearly expressed otherwise in the context. Terms, such as ‘include’ or ‘have’, should be understood to indicate the existence of a described characteristic, number, step, operation, element, part, or a combination of them and understood to not exclude the existence of one or more other characteristics, numbers, steps, operations, elements, parts, or a combination of them or a possibility addition of them.

All terms used herein, including technical or scientific terms, have the same meanings as those typically understood by those skilled in the art unless otherwise defined. Terms, such as ones defined in common dictionaries, should be construed as having the same meanings as those in the context of related technology and should not be construed as having ideal or excessively formal meanings unless clearly defined in this application.

Hereinafter, preferred embodiments of the present invention are described in more detail with reference to the accompanying drawings. In describing the present invention, in order to help general understanding, the same reference numerals are used to denote the same elements throughout the drawings and a redundant description of the same elements is omitted.

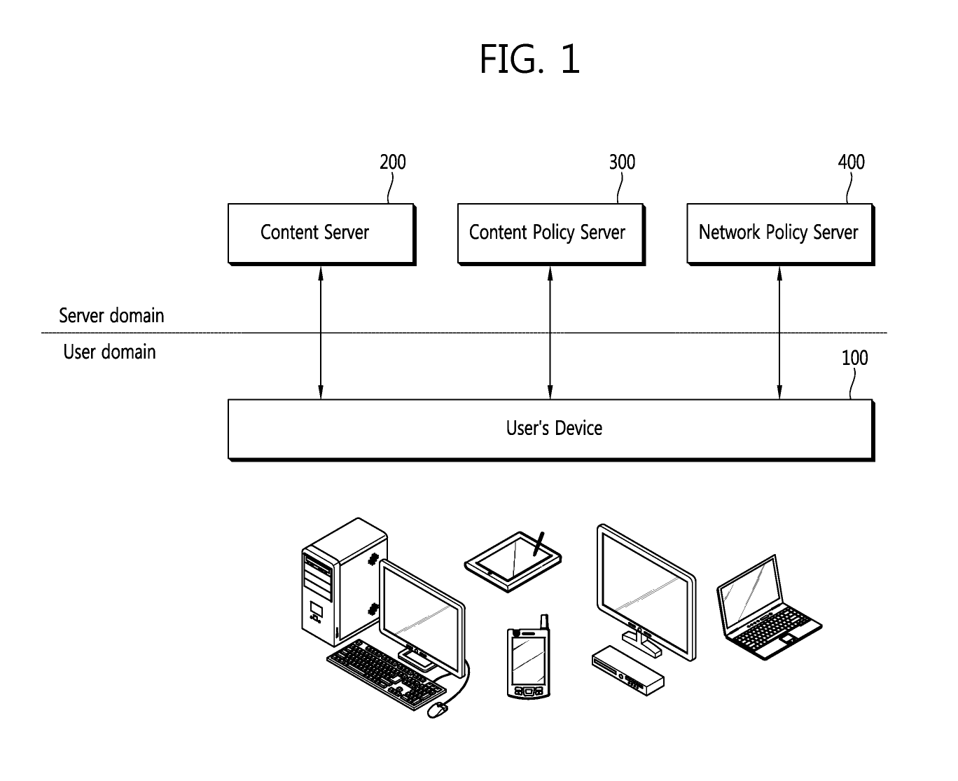

FIG. 1 is a block diagram showing the construction of a content service system to which a method for receiving content according to a preferred embodiment of the present invention can be applied.

As shown in FIG. 1, the content service system may be divided into a server domain and a user domain.

The server domain can operate a service, a network policy, etc. for content service and provide content to the user domain based on the policy. That is, the server domain may mean a domain that includes servers for providing content service. Such a server domain can perform the providing of content to the user domain, the operation of service for the user domain, and so on, such as the production, selling, distribution, policy operation, and rights limit of content.

The server domain may include a content server 200 for providing content, a content policy server 300 for operating policies for content services, a content policy server 400 for operating a network policy, etc. The number of content servers may be plural. For example, a server domain may include a content downloading server for downloading content, a content streaming server for streaming content, and so on.

The user domain may include the devices 100 of users. The devices 100 may be fixed type terminals, for example, a PC and a set-top box or may be portable terminals, for example, a smart phone, a portable phone, a mobile handset, a tablet, a Personal Digital Assistance (PDA), and a notebook. The devices 100 can access a local network based on UPnP, a DLNA, and so on and can operate in conjunction with each other through wired or wireless communication.

The device 100 of a user 100 may be a client device or an intermediate device.

The client device may mean a physical hardware device that is equipped with at least one network interface and a local storage. For example, the client device may be a mobile handset, a tablet, a smart phone, a PC or the like which can consume content. The client device CD may include modules for being supplied with content service.

The intermediate device may be a dual role client/server device on a network that may be used for the stage of an asset destined for a client device.

The intermediate device can temporarily hold an asset until the asset is delivered to a client device. In general, the intermediate device does not directly consume content, but may directly consume content.

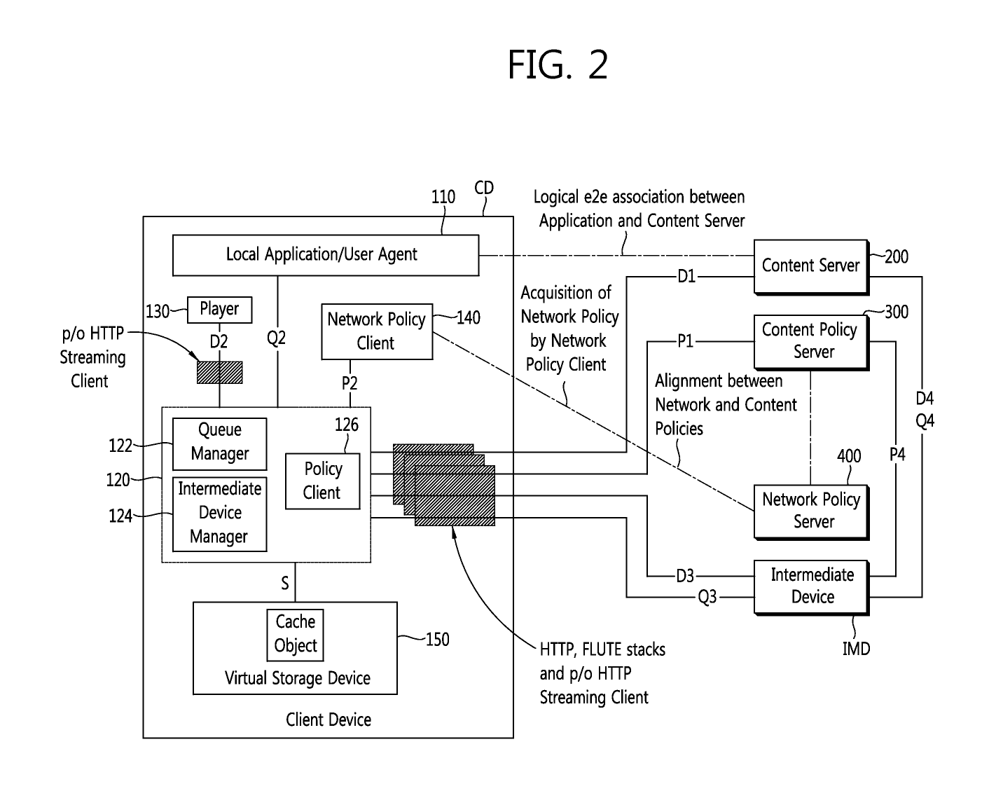

FIG. 2 is a block diagram illustrating a detailed structure of the client device of the content service system and related interfaces.

As shown in FIG. 2, the client device CD may include a local application 110, a player 130, a network policy client 140, a virtual storage device 150, a Queue/Policy Engine (QPE) 120, etc.

The local application 110 may mean an application for content service. For example, the local application 100 may be a user agent that provides a user interface, a service menu, service selection, content selection, etc. for allowing a user to be supplied with content service. Accordingly, the local application 110 may also be called a user agent.

The player 130 is for playing back content provided through content service and may be, for example, a media player capable of playing back download content or streaming content. The network policy client 140 can obtain a network policy while communicating with the network policy server 400 and control the client device CD according to the obtained network policy.

The virtual storage device 150 is a representation of a local depository that may be accessed through a cache object. For example, the virtual storage device 150 may be a common local depository, such as a hard disk, USB memory connected to a device, flash memory, a virtual region, such as Demon, and so on.

The QPE 120 is a module included in the client device CD, and it can perform communication through interface protocols P1, S, D1, D2, Q2, D3, and Q3. The QPE 120 can maintain a queue on behalf of each local application 110 and the content server 200 and interface with storage, and the QPE 120 can be responsible for synchronizing a queue request with a policy. Accordingly, the QPE may also be called a service client for content sharing service.

Such a QPE 120, that is, a QPE, may include a queue manager 122, a policy client 126, an intermediate device manager 124, etc.

The queue manager 122 can operate a queue for the download or streaming of content. For example, the queue manager 122 may include a stream queue manager and a download manager. The queue manager 122 may send a queue request to the intermediate device IMD and receive a corresponding response from the intermediate device IMD or may receive a queue request from the intermediate device IMD and send a corresponding response. For example, the queue manager 122 may send a queue request, requesting the intermediate device IMD to download specific content from the content server 200, to the intermediate device IMD and receive a corresponding response. The queue manager 122 may send a queue request, requesting the intermediate device IMD to send content downloaded from the content server 200 to the client device CD, to the intermediate device IMD.

The policy client 126 is a subsystem of the QPE 120, and it maintains a policy object. The policy client 126 can control the QPE 120 according to policies from the content policy server 300. For example, the policy client 126 can retrieve policies from the content policy server 300 and adjust a queue request behavior.

The intermediate device manager 124 can manage the intermediate devices IMD that operates in conjunction with the client device CD. For example, the intermediate device manager 124 can discover the intermediate device IMD connected to a network and manage the state of the intermediate device IMD. The intermediate device manager 124 can send or receive necessary messages to or from an intermediate device.

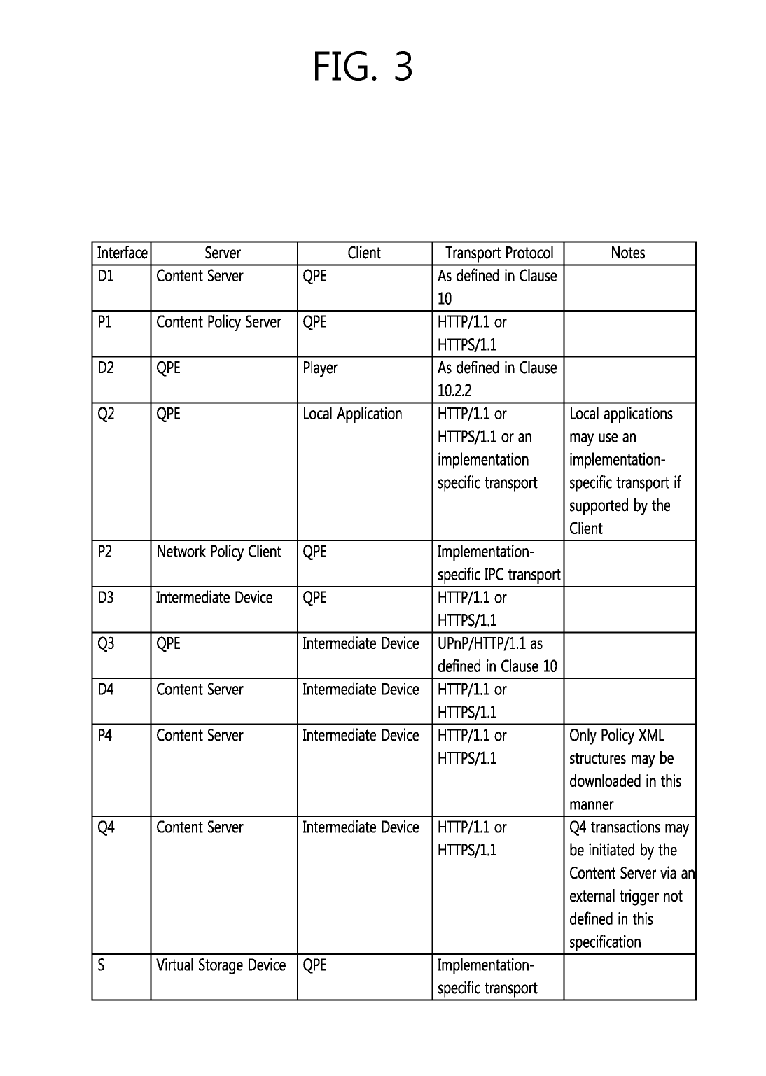

FIG. 3 is a table illustrating the interfaces shown in FIG. 2.

As shown in FIG. 3, interfaces related to the content service system may be classified into P, Q, S, and D interface groups. Each of the interfaces can operate in a client-server structure.

The P interface group can define a link and policy between the QPE 120 and the content policy server 300. Such a P interface group may include the interfaces P1 and P2. In the interface P1, a server may be the content policy server 300 and a client may be the QPE 120. In the interface P2, a server may be the network policy client 140 and a client may be the QPE 120. In the interface P4, a server may be the content server 200 and a client may be the intermediate device IMD.

The Q interface group can define queue request handling. The Q interface group may be a primary command channel that associates the content server 200, the intermediate devices IMD and the QPE 120 with each other. The Q interface group can allow a caching functionality to be called by the local application 110. In the Q2 interface, a server may be the QPE 120 and a client may be the local application 110. In the Q3 interface, a server may be the QPE 120 and a client may be the intermediate device IMD. In the Q4 interface, a server may be the content server 200 and a client may be the intermediate device IMD.

The S interface group can abstract storage and a cache capability to a QPE. In the S interface, a server may be the virtual storage device 150 and a client may be the QPE 120.

The D interface group can be used for the transmission of data. In the interface D1, a server may be the content server 200 and a client may be the QPE 120. In the interface D2, a server may be the QPE 120 and a client may be the player 130. In the interface D3, a server may be the intermediate device IMD and a client may be the QPE 120. In the interface D4, a server may be the content server 200 and a client may be the intermediate device IMD.

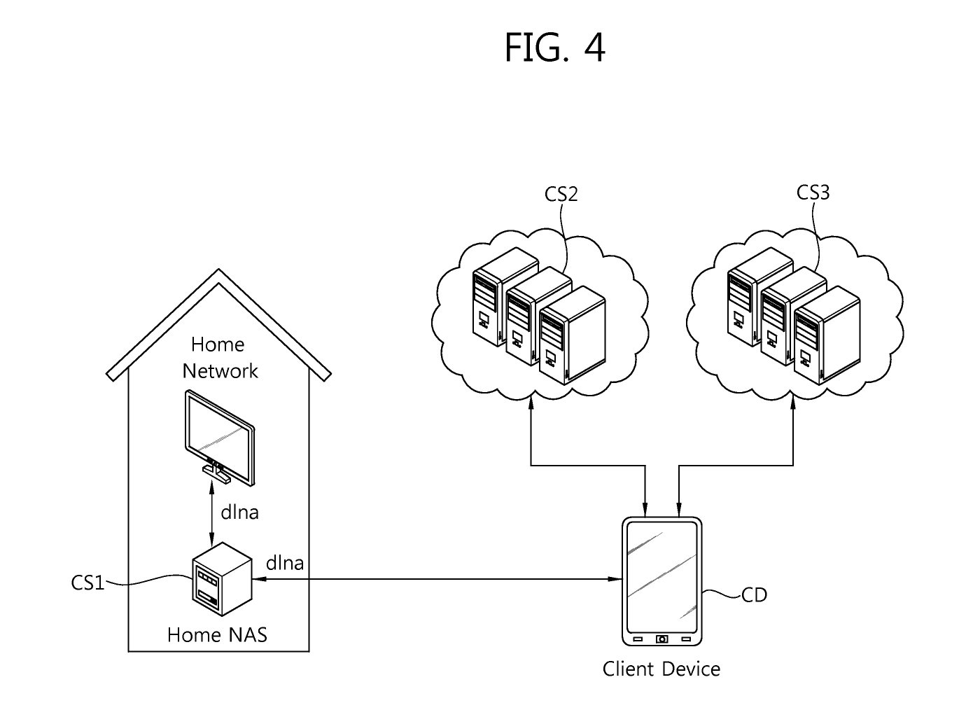

FIG. 4 is a block diagram illustrating the interoperation of devices related to the method for receiving content according to a preferred embodiment.

As shown in FIG. 4, a client device CD may be connected to a local network, for example, a home network based on DLNA or UPNP on one side and may operate in conjunction with home devices within the home network. The home devices may be, for example, Network Attached Storage (NAS), a Digital Media Server (DMS), a Digital Media Player (DMP), a Digital Media Controller (DMC), and a Digital Media Renderer (DMR). Meanwhile, the client device CD may be connected to the servers of a server domain, for example, a content downloading server and a content streaming server over a wide-area network.

The client device CD can search for content stored in a content source within the home network, for example, the NAS. In the present embodiment, the content source within the home network is called a first content source CS1. However, this is only an example, but the present invention is not limited thereto. The number of content sources within the home network that operate in conjunction with the client device CD may be one or plural. For example, the client device CD may search a plurality of content sources within the home network. Meanwhile, the client device CD may search for content that can be provided by the content sources of a server domain. In the present embodiment, an example in which the client device operates in conjunction with a second content source CS2 and a third content source CS3 is assumed and described. The second content source CS2 may be, for example, the content downloading server of a server domain. The third content source CS3 may be, for example, the content streaming server of a server domain. However, this is only an example, but the present invention is not limited thereto. The client device CD may operate in conjunction with various servers of a server domain.

The content may be multimedia, for example, a broadcasting program, a movie, a music video, or an advertisement or may be a sound source, an image, text, and so on. The client device CD can obtain a content list from at least one content source or generate a content list based on pieces of content that have been retrieved from each content source. The client device CD may generate a local integration content list, that is, a list of pieces of content stored in content sources within a local network, by integrating lists of pieces of contents obtained from the content sources or may generate an integration content list by integrating a list of pieces of content stored in a content source within the local network and a content source within a server domain.

The client device CD can display a generated content list via various user interfaces. When a user selects desired content in a content list in order to view or store content, the client device CD can select a content servers that operates in conjunction with the client device CD, for example, at least one of the first content source CS1, the second content source CS2, and the third content source CS3, receive the corresponding content from the selected content server, and download the received content or play back or store the received content in a streaming method.

The client device CD can search a plurality of content sources in which the content is stored and obtain at least one piece of source access information on which the corresponding content can be obtained from each retrieved content source. That is, a plurality of pieces of source access information on which the content can be provided is obtained from the plurality of content sources. Here, the source access information may be a Universal Resource Identifier (URI) of a source. The source URI is information for obtaining an asset and may be used to retrieve an asset via the D interface.

Each content source can provide a source URI by which the content can be transmitted. For example, the first content source CS1 can provide a first source URI, the second content source CS2 can provide a second source URI, and the third content source CS3 can provide a third source URI. Meanwhile, each content source may provide a plurality of source URIs on which the content can be transmitted. For example, the first content CS1, that is, a DLNA or UPnP device within the home network, may provide a source URI by which the content is provided in a progressive downloading method, a source URI by which the content is provided in a streaming method, a source URI by which transcoded content is provided, and so on in order to provide a piece of content. That is, one content source provides a plurality of source URIs.

As described above, each content source retrieved by the client device CD as described above can provide at least one (i.e., one or plural) source URIs in accordance with the content.

The client device CD can generate at least one queue request including a plurality of pieces of source access information. A queue request object may be called a mechanism for queuing an asset for downloading. The queue request is transmitted to a QPE by a local application, an intermediate device, or a content server via the Q2 and Q3 interfaces. The queue request includes information regarding what asset will be transmitted, from where the asset will be transmitted, when the asset will be transmitted, and how the asset will be transmitted between a client and a server over a network. The queue request may include at least one source URI by which the asset can be obtained. Such an URI can be used to retrieve the asset via a D interface.

The client device CD can generate a single queue request, including a plurality of pieces of source access information, in accordance with a plurality of pieces of source access information. For example, the client device CD may generate a queue request that includes first source access information about the first content source CS1, second source access information about the second content source CS2, and third source access information about the third content source CS3.

The client device CD can select source access information for receiving content from pieces of source access information included in the generated queue request. The client device CD can receive content from a corresponding content source using the selected source access information.

The client device CD selects source access information for receiving content from a plurality of pieces of source access information based on transmission bandwidth information corresponding to each piece of source access information, a selection signal received from a user interface.

As in the former, if source access information on which content will be received is selected based on bandwidth information corresponding to each piece of source access information, for example, the client device CD can request each content source to send the content for a predetermined time, estimate a bandwidth based on content downloading speed from each content source, and associate information about the bandwidth with source access information corresponding to the content source. The client device CD can analyze bandwidth information corresponding to a plurality of pieces of source access information and select source access information having the greatest bandwidth, for example. Accordingly, content can be received from a content source which has the best network state and can transmit the content rapidly.

As in the latter, if source access information is selected in response to a selection signal received from a user interface, the client device CD may display a source list, including a plurality of retrieved content sources (or pieces of source access information), via a user interface and select source access information corresponding to a selected content source when a user selects the desired content source. Accordingly, a user can receive content from a desired content source. Meanwhile, the client device CD may display bandwidth information corresponding to each content source in a source list and enable a user to select a desired content source with reference to the bandwidth information.

Meanwhile, the client device CD may generate a plurality of queue requests, each including a piece of source access information, in accordance with a plurality of pieces of source access information. For example, the client device CD may generate a first queue request including the first source access information of the first content source CS1, a second queue request including the second source access information of the second content source CS2, and a third queue request including the third content access information of the third content source CS3.

Each of the queue requests may include priority. To this end, the client device CD may set priority corresponding to each queue request based on transmission bandwidth information corresponding to each piece of source access information, priority information received from a user interface, content transmission condition information, etc.

For example, the client device CD may assign high priority to a queue request corresponding to the source access information of a content source having a great bandwidth and assign low priority to a queue request corresponding to the source access information of a content source having a small bandwidth based on transmission bandwidth information corresponding to each piece of source access information. Alternatively, the client device CD may display a source list via a user interface and assign priority to each queue request based on inputted priority when a user inputs the priority. Meanwhile, the client device CD may assign priority to a queue request based on content transmission condition information. Here, the content transmission condition information may be bandwidth information, whether progressive downloading is supported or not, whether streaming is supported or not, whether transcoded content streaming is supported or not, etc. Priority information according to the content transmission condition information may be previously set in a client device.

Each queue request may include queue request priority indicative of priority for the corresponding queue request. The queue request priority may be an integer value within a specific range, for example, an integer value from 0 to 100. Here, 0 may be a value indicating a special meaning and may be, for example, a value indicating that priority has not been set. For example, if a queue request priority field in a queue request is a value of 0, the queue request may be a queue request in which priority has not been set. If a value of a queue request priority field in a queue request is a value more than 100, the queue request may be neglected as an error. Meanwhile, if a value of the queue request priority field of a queue request is a value from 1 to 100, the value may be compared with a value of the queue request priority of another queue request. Here, a smaller priority value may indicate higher priority. In accordance with embodiments, a higher priority value may indicate higher priority.

The client device CD may preferentially perform a queue request having the highest priority, of a plurality of queue requests. For example, a queue request having the highest priority may shift to an active state, and a queue request having priority lower than the highest priority may shift to any one of a blocked state, a waiting state, and a suspended state. That is, the client device first performs a queue request having the highest priority.

Hereinafter, embodiments in which the client device CD receives the same content as content stored in the first content source CS1, that is, a home device, from the second content source CS2, that is, the downloading server of a server domain, or the third content source CS3, that is, a streaming server, instead of the content stored in the first content source CS1 are described. The following description is only an example of the embodiment, and the client device CD may receive the same content as content stored in a home device from another home device in which the same content is stored, instead of the content stored in the home device, or may receive the same content as content stored in the content source of a server domain from a home device in which the same content is stored, instead of the content as stored in the content source.

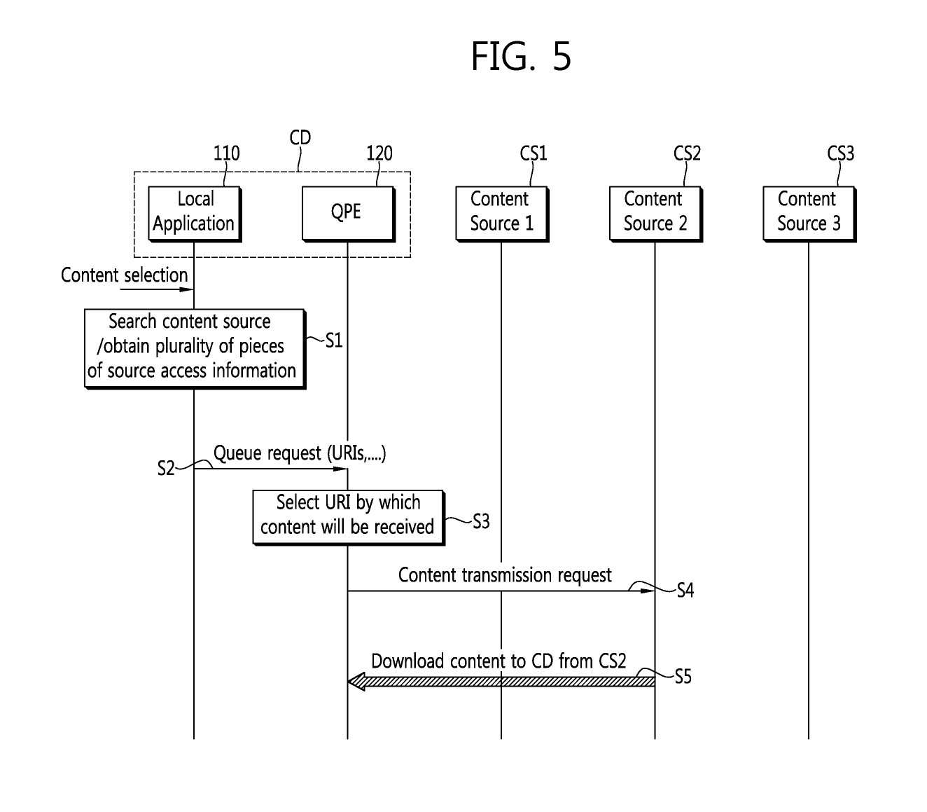

FIG. 5 is a flowchart illustrating the method for receiving content according to a preferred embodiment of the present invention.

As shown in FIG. 5, first, the local application 110 of the client device CD can search for pieces of content stored in the first content source CS1 and display a content list. A user can designate content to be viewed in the displayed content list using specific input means. In response thereto, the client device CD can select the content in response to a signal received from the input means.

When the content is selected, the local application 110 obtains corresponding source access information from the first content source CS1.

Furthermore, the local application 110 can search other content sources, for example, the second content source CS2 and the third content source CS3 for the same content as the selected content and obtain a plurality of pieces of source access information from the content sources CS2 and CS3. That is the local application 110 obtains a plurality of pieces of source access information from the plurality of content sources CS1, CS2, and CS3 (step: S1).

The source access information may be a source URI. As described above, the source URI is information for obtaining an asset and used to retrieve an asset via the D interface. For example, the local application 110 may obtain the first source URI of the first content source CS1, the second source URI of the second content source CS2, and the third source URI of the third content source CS3. Meanwhile, this is only an example of the embodiment, and the client device CD may obtain a plurality of source URIs from one content source or obtain source URIs from a plurality of devices within a local network. For example, the client device CD may obtain a plurality of source URIs, for example, a source URI by which the content is provided in a progressive downloading manner, a source URI by which the content is provided in a streaming manner, and a source URI by which transcoded content is provided from the first content CS1, that is, a DLNA or UPnP device within the home network. Furthermore, the client device CD may obtain a plurality of URIs from a plurality of DLNA or UPnP content sources. Thereafter, the local application 110 generates a queue request including the plurality of obtained source URIs and sends the generated queue request to the QPE 120 via the Q2 interface (step: S2). The queue request may include a codec type media profile, a container type, a Multipurpose Internet Mail Extension (MIME) type, a store name, the total length of the queue request, content information, and policy information in addition to the plurality of source URIs. Here, the plurality of source URIs needs to refer to the same asset, and the asset should not be modified during the lifetime of the queue request.

The QPE 120 that has received the queue request can select at least one of the source URIs included in the queue request (step: S3). For example, the QPE 120 may select the second source URI of the second content source CS2, that is, the content downloading server of a server domain, from the plurality of source URIs. The client device CD can send a content transmission request to the second content source CS2 using the selected second source URI (step: S4) and download the content from the second content source CS2 (step: S5).

As described above, in accordance with the embodiment shown in FIG. 5, the client device CD can download content stored in the first content source CS1, that is, a home device, from the second content source CS2 of a server domain and store the downloaded content. Meanwhile, the client device CD may select source access information on which the content will be received based on a bandwidth between the content sources CS1, CS2, and CS3 and the client device CD, input from a user interface, etc. Such embodiments are described in detail below.

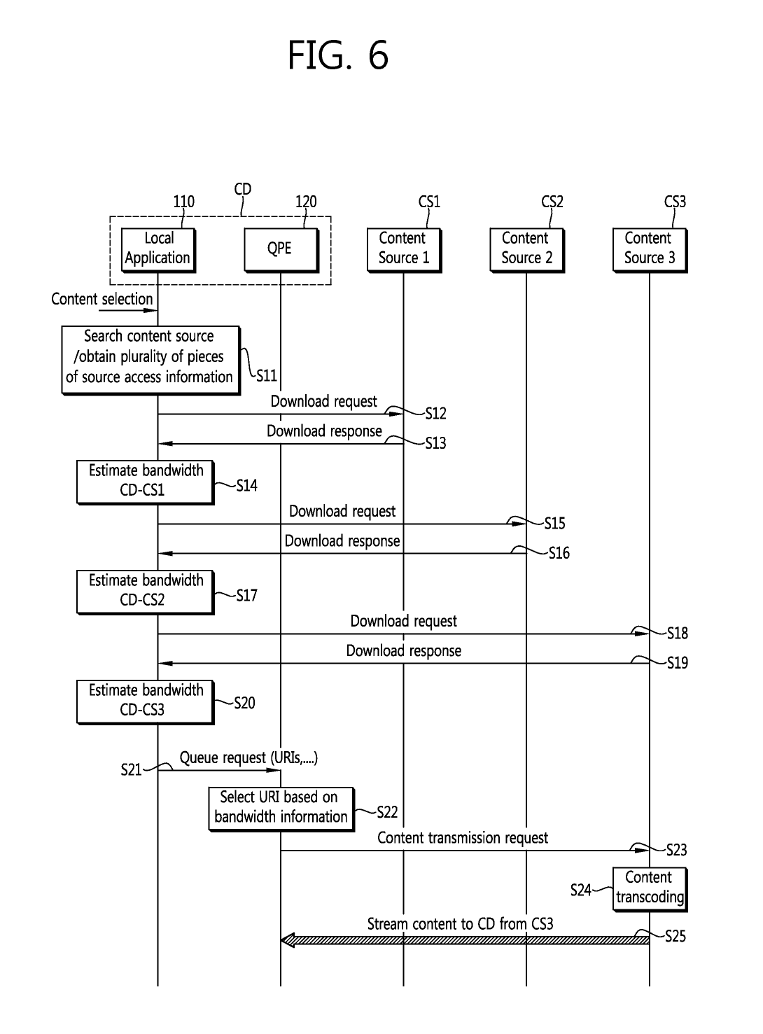

FIG. 6 is a flowchart illustrating a method for receiving content according to another preferred embodiment of the present invention.

As shown in FIG. 6, first, the local application 110 of the client device CD can search for pieces of content stored in the first content source CS1, that is, the NAS of a local network, and display a content list. A user can designate content to be viewed in the displayed content list using input means capable of inputting a signal to the client device CD. In response thereto, the client device CD can select the content in response to a signal received from the input means.

When the content is selected, the local application 110 obtains corresponding source access information from the first content source CS1. Furthermore, the local application 110 can search other content sources, for example, the second content source CS2 and the third content source CS3 for the same content as the selected content and obtain a plurality of pieces of source access information from the content sources CS2 and CS3. That is, the local application 110 obtains a plurality of pieces of source access information, for example, a first source URI, a second source URI, and a third source URI from a plurality of content sources, for example, the first content source CS1, the second content source CS2, and the third content source CS3 (step: S11).

Thereafter, the client device CD can request content downloading for a bandwidth test from the content sources CS1, CS2, and CS3 using the respective pieces of source access information (step: S12, S15, S18) and download part of the pieces of content from the content sources CS1, CS2, and CS3 for a predetermined time, for example, several seconds (step: S13, S16, S19). Furthermore, the local application 110 can estimate bandwidths corresponding to the respective pieces of source access information based on the content downloading during the time (step: S14, S17, S20).

For example, the local application 110 can request downloading from the first content source CS1 using the first source URI (step: S12), download part of the content for the predetermined time (step: S13), and estimate a transmission bandwidth between the first content source CS1 and the client device CD, that is, a bandwidth corresponding to the first source URI, based on downloading speed of the content (step: S14). Likewise, the local application 110 can request downloading from the second content source CS2 using the second source URI (step: S15), download part of the content for a predetermined time (step: S16), and estimate a transmission bandwidth between the second content source CS2 and the client device CD, that is, a bandwidth corresponding to the second source URI, based on downloading speed of the content (step: S17). Furthermore, the local application 110 can request downloading from the third content source CS3 using the third source URI (step: S18), download part of the content for the predetermined time content (step: S19), and estimate a transmission bandwidth between the third content source CS3 and the client device CD, that is, a bandwidth corresponding to the third source URI, based on downloading speed of the content (step: S20).

The local application 110 can store the pieces of estimated bandwidth information in the memory of the client device CD by matching the pieces of estimated bandwidth information with the respective source URIs. The pieces of stored bandwidth information can be searched for by the QPE 120. Meanwhile, the bandwidth information may be included in the queue request.

Next, the local application 110 generates a queue request including the plurality of obtained source URIs and sends the generated queue request to the QPE via the Q2 interface (step: S21). The queue request may include a codec type media profile, a container type, a Multipurpose Internet Mail Extension (MIME) type, a store name, the total length of the queue request, content information, policy information, etc. in addition to the plurality of source URIs. The queue request may include bandwidth information about each of the source URIs estimated by the local application 110. The plurality of source URIs needs to refer to the same asset, and the asset should not be modified during the lifetime of the queue request.

The QPE 120 that has received the queue request can select at least one of the source URIs, included in the queue request, based on the bandwidth information corresponding to each of the source URIs (step: S22). For example, the QPE 120 may compare the pieces of bandwidth information corresponding to the plurality of source URIs with each other and select, for example, the third source URI of the third content source CS3, that is, the content streaming server of a server domain having the greatest bandwidth. If the bandwidth information corresponding to each of the source URIs is included in the queue request, the QPE 120 can obtain the bandwidth information through the queue request. If the bandwidth information corresponding to each of the source URIs is not included in the queue request, the QPE 120 can obtain the bandwidth information from the memory.

The QPE 120 that has selected the source URI can send a content transmission request to the selected content source using the selected source URI. For example, the QPE 120 that has selected the third source URI can send the content transmission request to the third content source CS3 using the third source URI (step: S23). In response thereto, the third content source CS3 can transcode the requested content in real time so that the content is suitable for the client device CD (step: S24) and stream the transcoded content to the client device CD (step: S25). The content transmission request may include pieces of information for transcoding, for example, the device capability of the client device CD.

As described above, in accordance with the embodiment described with reference to FIG. 6, the client device CD can select source access information on which content will be received based on a bandwidth between the content sources CS1, CS2, and CS3 and the client device CD. Accordingly, if a communication state between the first content source CS1 and the client device CD is not good, the client device CD can rapidly receive content from the third content source CS3 having an excellent communication state in a streaming manner. Accordingly, a user can view content, played back by the client device CD, without an interruption due to reception delay.

Meanwhile, in accordance with yet another preferred embodiment of the present invention, the client device CD may select source access information on which content will be received based on a selection signal that is received via a user interface. For example, the client device CD may display a source list, including a plurality of retrieved content sources (or pieces of source access information), via a user interface and select source access information corresponding to a selected content source when a user selects the desired content source via the user interface. In such a case, the client device CD can receive content from the content source desired by the user.

Furthermore, when displaying the source list including the plurality of retrieved content sources or the pieces of retrieved source access information via the user interface, the client device CD may display bandwidth information, corresponding to each of the content sources, in the source list and provide information so that a user can select a desired content source with reference to the bandwidth information.

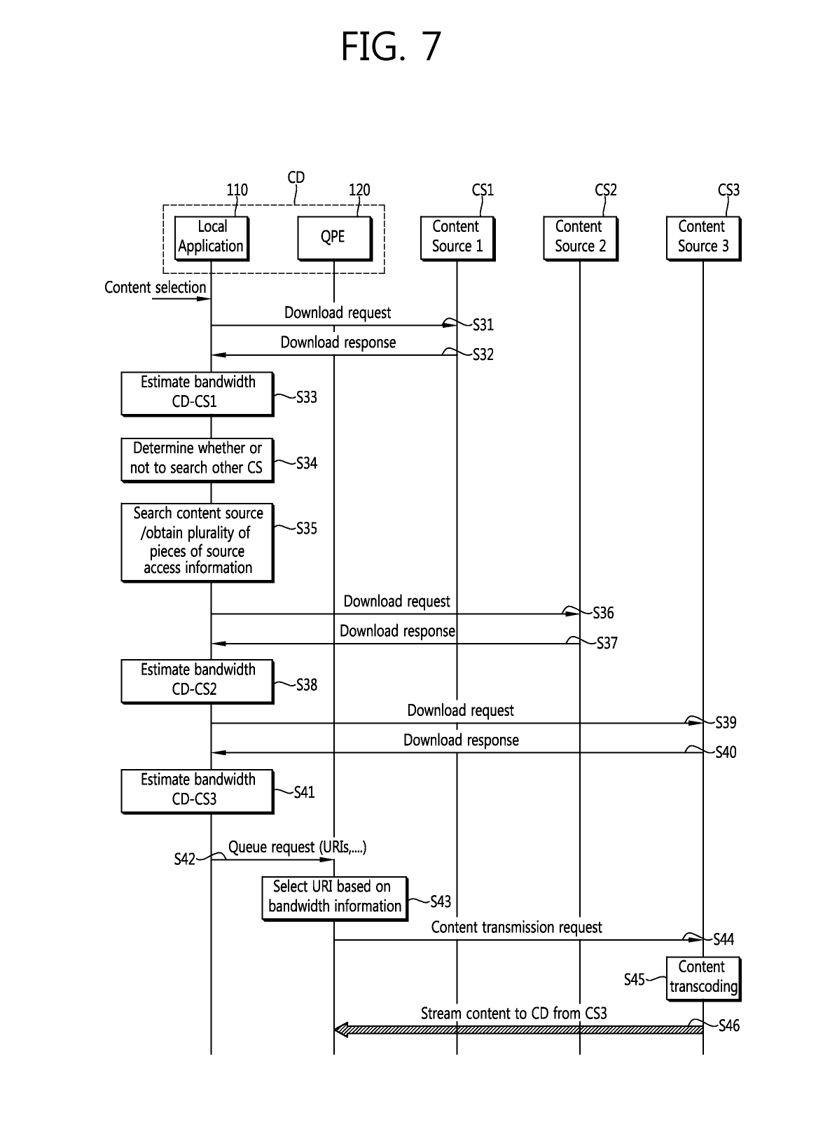

Hereinafter, there is described a case where whether or not a content source and a source URI will be searched for or not in accordance with yet another preferred embodiment of the present invention is selectively performed. FIG. 7 is a flowchart illustrating a method for receiving content according to yet another preferred embodiment of the present invention.

As shown in FIG. 7, first, the local application 110 of the client device CD can search for pieces of content stored in the first content source CS1, that is, the NAS of a local network, and display a content list. A user can designate content to be viewed in the displayed content list using input means. In response thereto, the client device CD can select the content in response to a signal received from the input means.

When the content is selected, the local application 110 obtains a first source URI by which the content can be provided from the first content source CS1. Thereafter, the client device CD requests content downloading from the first content source using the first source URI for a bandwidth test (step: S31) and downloads part of the content for a predetermined time (step: S32).

The local application 110 estimates a bandwidth corresponding to the first source URI based on the content downloading for the predetermined time (step: S33) and determines whether or not to search other content sources in which the same content as the content is stored based on the estimated bandwidth of the first source URI (step: S34).

For example, the local application 110 may determine whether or not the bandwidth of the first source URI is a set reference bandwidth or more and determine to search other content sources if the bandwidth of the first source URI is smaller than the reference bandwidth. Meanwhile, if the bandwidth of the first source URI is the set reference bandwidth or more, the local application 110 may send a queue request including the first source URI to the QPE 120, and the QPE 120 may receive the content from the first content source CS1 using the first source URI.

If it is determined that other content sources are searched, the local application 110 may search the devices of a local network and a server domain for other content sources from which the same content as the content can be provided, for example, the second content source CS2 and the third content source CS3. Furthermore, the local application 110 may obtain a plurality of pieces of source access information, for example, the second source URI and the third source URI from the retrieved content sources CS2 and CS3 (step: S35).

Thereafter, the local application 110 can request the downloading of the content from the corresponding content sources CS2 and CS3 using the respective pieces of source access information obtained at step S35 (step: S36, S39) and download part of the content from the respective content sources CS2 and CS3 for a predetermined time, for example, for several seconds (step: S37, S40). Furthermore, the local application 110 can estimate bandwidths corresponding to the respective pieces of source access information based on the content downloading for the predetermined time (step: S38, S41).

The local application 110 can store the pieces of estimated bandwidth information in the memory of the client device CD by matching the pieces of estimated bandwidth information with the respective source URIs. The pieces of stored bandwidth information can be searched for by the QPE 120. Meanwhile, the pieces of bandwidth information may be included in the queue request.

Next, the local application 110 generates a queue request including the plurality of obtained source URIs and sends the generated queue request to the QPE 120 via the Q2 interface (step: S42). The queue request may include a codec type media profile, a container type, a Multipurpose Internet Mail Extension (MIME) type, a store name, the total length of the queue request, content information, policy information, etc. in addition to the plurality of source URIs. The queue request may include bandwidth information about each of the source URIs estimated by the local application. The plurality of source URIs needs to refer to the same asset, and the asset should not be changed during the lifetime of the queue request.

The QPE 120 that has received the queue request can select at least one of the source URIs included in the queue request based on the pieces of bandwidth information corresponding to the respective source URIs (step: S43). For example, the QPE 120 may select the third source URI of the third content source CS3, that is, the content streaming server of a server domain having a great bandwidth by comparing the pieces of bandwidth information corresponding to the plurality of source URIs with each other. The QPE 120 may obtain the bandwidth information corresponding to each of the source URIs through the queue request if the bandwidth information is included in the queue request and may obtain the bandwidth information corresponding to each of the source URIs from the memory if the bandwidth information is not included in the queue request.

The QPE 120 that has selected the source URI can send a content transmission request to the selected content source CS3 using the selected source URI. For example, the QPE that has selected the third source URI may send the content transmission request using the third source URI (step: S44). In response thereto, the third content source CS3 can transcode the requested content in real time so that the requested content is suitable for the client device CD (step: S45) and stream the transcoded content to the client device CD (step: S46). The content transmission request may include pieces of information for transcoding, for example, the device capability of the client device CD.

The embodiments in which a source URI by which content will be received is selected based on a queue request including a plurality of source URI have been described above. There is described below an embodiment in which a source URI by which content will be received is selected from a plurality of source URIs by processing a plurality of queue requests corresponding to the plurality of source URIs based on priority assigned to each queue request.

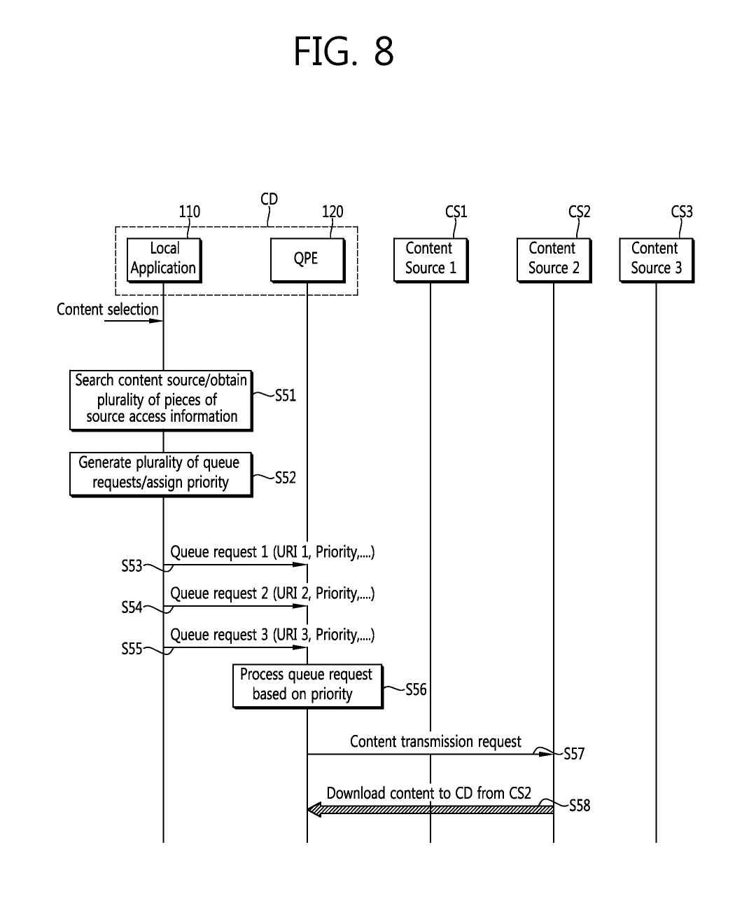

FIG. 8 is a flowchart illustrating a method for receiving content according to yet another preferred embodiment of the present invention.

As shown in FIG. 8, first, the local application 110 of the client device CD can search for pieces of content stored in the first content source CS1, that is, the NAS of a local network, and display a content list. A user can designate content to be view in the displayed content list using input means. In response thereto, the client device CD can select the content in response to a signal received from the input means.

When the content is selected, the local application 110 obtains corresponding source access information from the first content source CS1. Furthermore, the local application 110 can search other content sources, for example, the second content source CS2 and the third content source CS3 for the same content as the selected content and obtain a plurality of pieces of source access information from the content sources CS2 and CS3. That is, the local application 110 obtains a plurality of pieces of source access information, for example, the first source URI, the second source URI, the third source URI from a plurality of content sources, for example, the first content source CS1, the second content source CS2, and the third content source CS3 (step: S51).

Thereafter, the client device CD can generate a plurality of queue requests including the plurality of pieces of obtained source access information and assign priority to each of the queue requests based on the bandwidth information of each of the pieces of source access information or information received from a user interface (step: S52).

For example, the local application 110 may generate a first queue request including the first source URI, a second queue request including the second source URI, and a third queue request including the third source URI. The local application 110 can estimate a first bandwidth, a second bandwidth, and a third bandwidth corresponding to the first source URI, the second source URI, and the third source URI by performing steps S12 to S20 of FIG. 6 or steps S31 to S41 of FIG. 7. Here, assuming that the second bandwidth is the greatest, the third bandwidth is the second greatest, and the first bandwidth is the smallest, the local application 110 can set priority in order of greater bandwidths. That is, the highest priority is assigned to the second queue request, and the lowest priory is assigned to the first queue request. The local application 110 inserts information about the set priority in each queue request. The information about priority may be called queue request priority.

Meanwhile, the local application 110 may display a user interface including the plurality of obtained content sources or obtained source URIs and set priority in each queue request based on priority corresponding to each source URI in response to a user input when the priority corresponding to the source URI is received from a user interface. The local application 110 can insert the queue request priority according to the set priority into each of the queue requests.

Next, the local application 110 can send the plurality of generated queue requests, for example, the first queue request, the second queue request, and the third queue request to the QPE 120 (step: S53, S54, S55). The third queue request can include the third source URI and the third queue request priority. The second queue request can include the second source URI and the second queue request priority. The first queue request can include the first source URI and the first queue request priority. Each of the queue requests may include a codec type media profile, a container type, a Multipurpose Internet Mail Extension (MIME) type, a store name, the total length of the queue request, content information, policy information, etc.

The QPE 120 that has received the plurality of queue requests processes the queue requests based on the priorities (step: S56). The QPE 120 can preferentially process the queue request having the highest priority, of the plurality of queue requests. For example, the second queue request having the highest priority may shift to an active state, and a queue request having priority lower than the highest priority may shift to any one of a blocked state, a waiting state, and a suspended state. That is, the QPE preferentially processes the queue request having the highest priority. The remaining queue requests may be discarded according to a specific condition, such as that the queue request having the highest priority is successfully completed or a predetermined time expires. If a queue request having high priority is not successfully completed, a queue request having lower priority may shift to an active state and may be then performed.

For example, the QPE 120 may send a content transmission request to the second content source CS2 using the second source URI in response the queue request having the highest priority, for example, the second queue request (step: S57) and receive the content from the second content source CS2 (step: S58). If processing on the second queue request is completed, the third queue request or the first queue request may be discarded although they are not performed. If processing on the second queue request is not normally performed, a content transmission request according to the third queue request having next priority can be performed.

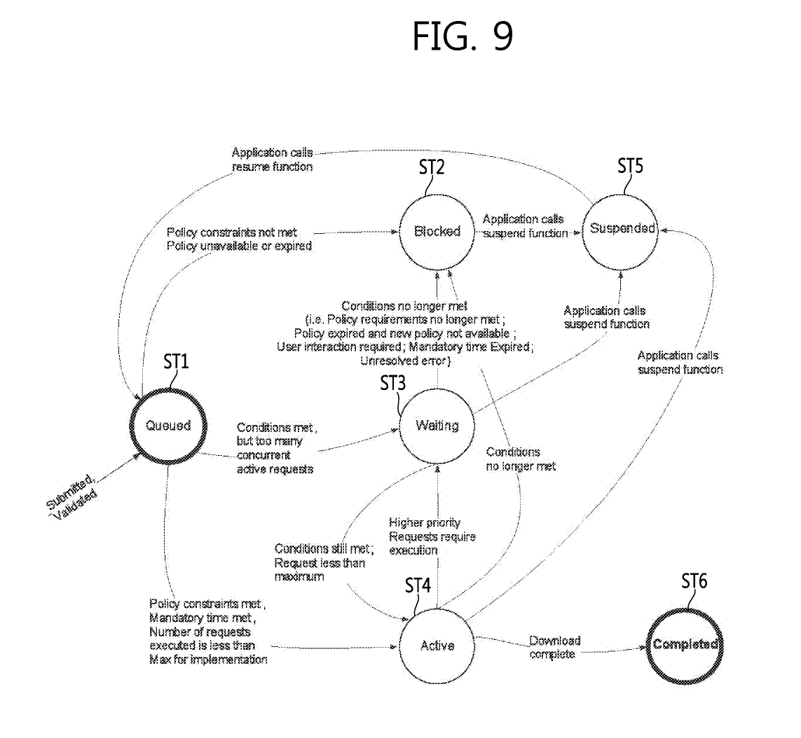

FIG. 9 shows a diagram for illustrating the life cycle of a queue request and a change of the state.

As shown in FIG. 9, in order for a request to shift to a queued (ST1) state, first, if the request is valid and freed from an error, a queue request ID is assigned to the request. An invalid request cannot be placed in a queue, and a queue request ID is not assigned to the invalid request. A queue request may have a policy for setting a criterion or rule that constrain that the queue request should be processed how and when. If no policy has been specified, a behavior for downloading and caching makes a policy as if the policy is set to a true constant.

A queued request that has been newly submitted depending on the policy of a request and a current operating condition of a client device CD can shift to a blocked (ST2), waiting (ST3), or active (ST4) state. For example, if a current operating condition of a client device CD does not satisfy a criterion defined by the policy of a request, a queue request shifts to the blocked (ST2) state. If a current operating condition of a client device CD satisfies a criterion for a request, but a request having higher priority is processed, a corresponding queue request shifts to the waiting (ST3) state. That is, a request having higher priority can be processed prior to a waiting request. If a current operating condition of a client device CD satisfies the policy of a request, a corresponding queue request needs to shift to the active (ST4) state, and the request has the highest priority for downloading.

If a request having higher priority is requested to be processed, a request in the active (ST4) state shifts to the waiting (ST3) state. If a constraint that defines the policy of a request is no longer satisfied according to a current operating condition of a client device CD or an error that requires an application interaction (e.g., HTTP 402 payment that requires state code) in performing a request is caused, the request in the active (ST4) state may shift to the blocked (ST2) state.

If one request is assigned to an essential time necessary to perform the request and there is no constraint in a client device environment in which the execution of a policy or request is blocked, the request may shift to the active (ST4) state. If a plurality of requests is assigned to an essential time necessary to perform the requests and all the requests cannot be served due to a client side limit that temporarily suspends a request in which a client device CD does not have the time assigned thereto, a request having the highest priority shifts to the active (ST4) state. A request that is not served can shift to the blocked (ST2) state due to the invalidation of a higher priority time-critical request assigned to a specific time. A request that has been temporarily suspended due to the execution of a request having an essential time for execution can shift to the waiting state.

A process of generating such a queue request is described below.

First, the local application 110 generates a deferred transmission request-queue request object in response to a request from a user, etc. The local application 110 can generate the queue request object b retrieving an XML queue request structure from a server or another object that generates a queue request structure. The queue request XML structure may include a rule object that specifies a network rule specified by the network policy client 140 and may include a URI reference for a policy that is placed in a rule content policy server.

The local application 110 can submit a queue request by invoking a request manager-submission request via the Q2 interface. The QPE 120 can retrieve the queue request and verify the retrieved queue request. The verification can be accompanied by checking for possible policy abidance, checking for a supported D interface scheme, property verification of the queue request, etc. If the queue request is verified, the QPE 120 can set a queue request state to ‘submitted’, assign a request ID to the queue request, and return the call of the local application 110 at that time. If the queue request is not submitted, error code can be returned.

Meanwhile, in accordance with yet another preferred embodiment of the present invention, the client device CD can set priority based on content transmission condition information and select source access information for receiving content by processing a queue request according to the set priority. Here, the content transmission condition information may be bandwidth information, whether progressive downloading is supported or not, whether streaming is supported or not, whether transcoded content streaming is supported or not, etc. Priority information according to the content transmission condition information can be previously set in the client device.

For example, when specific content is selected in a content list, a local application can search for a first content source, a second content source, and a third content source in which the selected content is stored through a content source search and obtain a plurality of source URIs. For example, it is assumed that a client device has obtained a first source URI, a fourth source URI, and a fifth source URI from the first content source, a second source URI from the second content source, and a third source URI from the third content source.

The local application can obtain pieces of content transmission condition information corresponding to each of the source URIs, for example, transmission bandwidth information, whether progressive downloading is supported or not, whether streaming is supported or not, and whether transcoded content streaming is supported or not from each of the content sources, that is, the first content source, the second content source, and the third content source. Meanwhile, priority according to content transmission condition information is previously stored in the client device in a table form. For example, it is assumed that the table has been set like “bandwidth”>“progressive download support”>“streaming support”, “transcoded streaming support”.

The local application can set priority for a queue request corresponding to each source URI based on the content transmission condition information corresponding to each of the obtained source URIs. For example, if the first source URI has the greatest bandwidth, the fourth source URI supports progressive downloading, the fifth source URI supports streaming, and the third source URI supports transcoded streaming, the local application can assign the highest priority to a first queue request including the first source URI, the second highest priority to a fourth queue request including the fourth source URI, the third highest priority to a fifth queue request including the fifth source URI, and the lowest priority to a third queue request including the third source URI.

Meanwhile, the local application can display a user interface including the plurality of obtained content sources and source URIs and display the content transmission condition information in the user interface. In such a case, priority may be assigned based on priority information received via the user interface in response to a user' selection.

The local application can send the plurality of generated queue requests to the QPE. In response thereto, the QPE can process the queue requests according to the priorities. Accordingly, the client device can download content using the first source URI having the highest priority. If a problem arises in the downloading, the client device can receive the content using the fourth source URI having the second priority.

Meanwhile, in the aforementioned embodiments, for example, the embodiments described with reference to FIGS. 5 to 8, when the client device selects a content source, the client device may receive pieces of capability information related to each content source, for example, information about the size of target content of the content source, information about the format of the content, information about the streaming protocol of the content, a transport method, and information about the bandwidth of an interface with the content source and select the content source based on the received capability information. The client device may request pieces of specific capability information from the content source or send capability information for the client device in response to a request from the content source. Device capability items transmitted between a content source and a client device are described below.

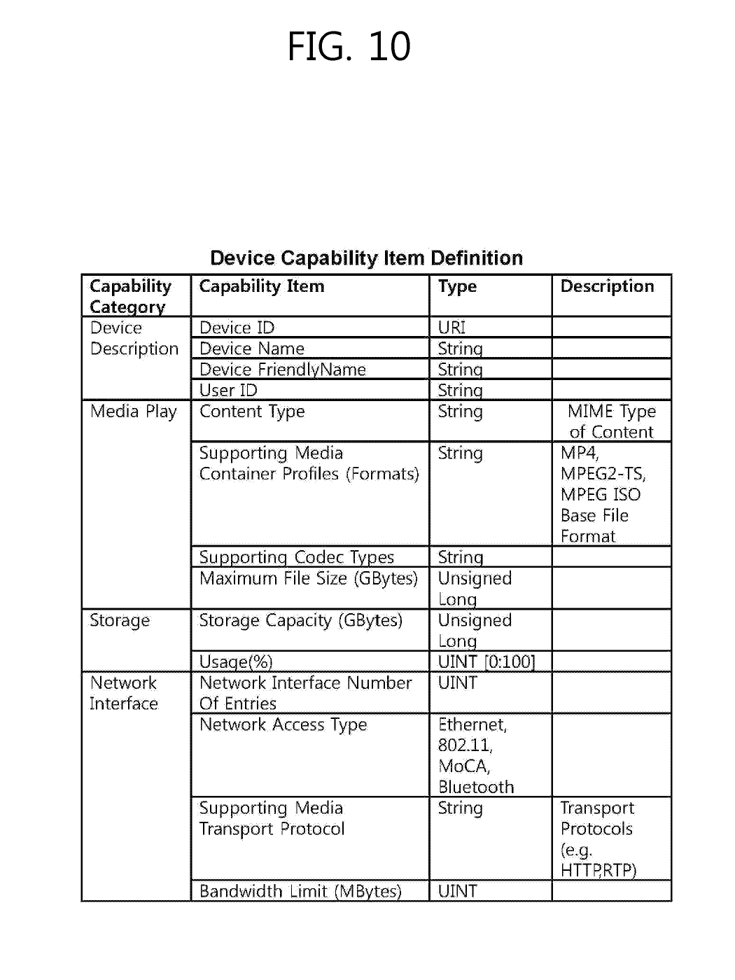

FIG. 10 shows a table illustrating device capability items.

As shown in FIG. 10, the capability category of a device may be classified into a device description, media play, storage, and a network interface.

The device description may include a device ID, a device name, a device friendly name, and a user ID. The device ID may mean an identifier for identifying a device globally and uniquely. A value of the device ID may be, for example, URI information. The device name may mean a universally unique identifier for a device. A value of the device name may be, for example, string type information. The device friendly name is a short description for an end user, and a value of the device friendly name may be string type information. The user ID is an identifier to identify an end user, and a value of the user ID may be string type information.

The media play may include a content type, supporting media container profiles (formats), supporting codec types, and a maximum file size. The content type may be, for example, an MIME type of content. The supporting media container profiles may indicate a supportable media profile type. For example, a value of the supporting media container profiles is string type information and may be set to, for example, ‘HD’ indicative of High Definition (HD), ‘SD’ indicative of Standard Definition (SD), ‘PD’ indicative of Portable Definition (PD), or the like. The supporting codec types are a list of supported codec types, and a value of the supporting codec types may be string type information. The maximum file size may be information indicative of a maximum size of content.

The storage may include a storage capacity and usage. The storage capacity may indicate the available amount of the storage. The storage capacity may indicate a storage capacity of a device. The usage may indicate the total amount of available storage. A value of the storage usage may be a percentage. For example, if a value of the storage usage is ‘0’, it may mean that the storage is completely unoccupied. If a value of the storage usage is ‘100’, it may mean that the storage is fully occupied.

The network interface may include the network interface number of entries, a network access type, a supporting media transport protocol, a bandwidth limit, etc. The network interface number of entries may indicate the number of network interfaces. The network access type may indicate an available network access interface type. A value of the network access type may be string type information. A value of the network access type may be, for example, ‘Ethernet’, ‘801.11’, ‘Bluetooth’, or ‘3G’ ‘WiMAX’. The supporting media transport may indicate a supported transport protocol type for the D3, D4, and D1 interfaces. A value of the media transport may be, for example, ‘HTTP’ or ‘RTP’. The bandwidth limit may indicate an available bandwidth of a network interface.

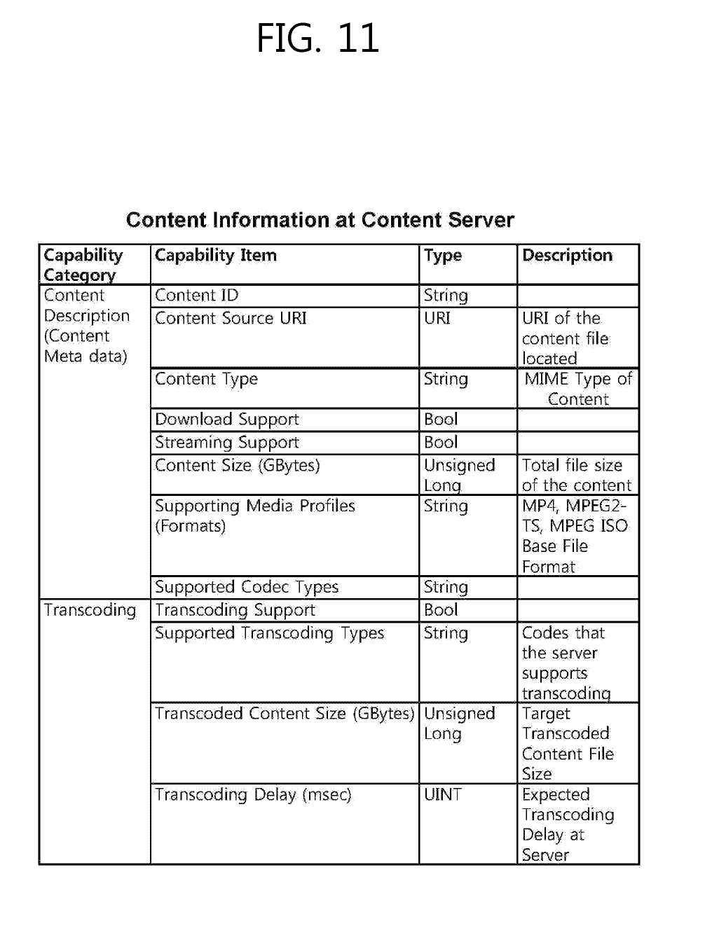

FIG. 11 is a table illustrating content information managed and provided by a content source.

As shown in FIG. 11, content information managed and provided by a content source can be basically divided into two categories, for example, a content description and transcoding.

The content description may be content metadata associated with content. The content description may include a content ID for identifying content, a content source URI indicative of information about the position and ID of a source from which content can be received, a content type indicative of the MIME type of content, download support indicative of whether a downloading method is supported or not, streaming support indicative of whether a streaming method is supported or not, a content size indicative of the size of content, a supporting media profile indicative of supportable media profile information, a supported codec type indicative of a supported codec type, etc.

The transcoding may include transcoding support indicative of whether transcoding is supported or not, a supported transcoding type, a transcoded content size indicative of the size of transcoded content, transcoding delay indicative of the delay time due to transcoding, etc.

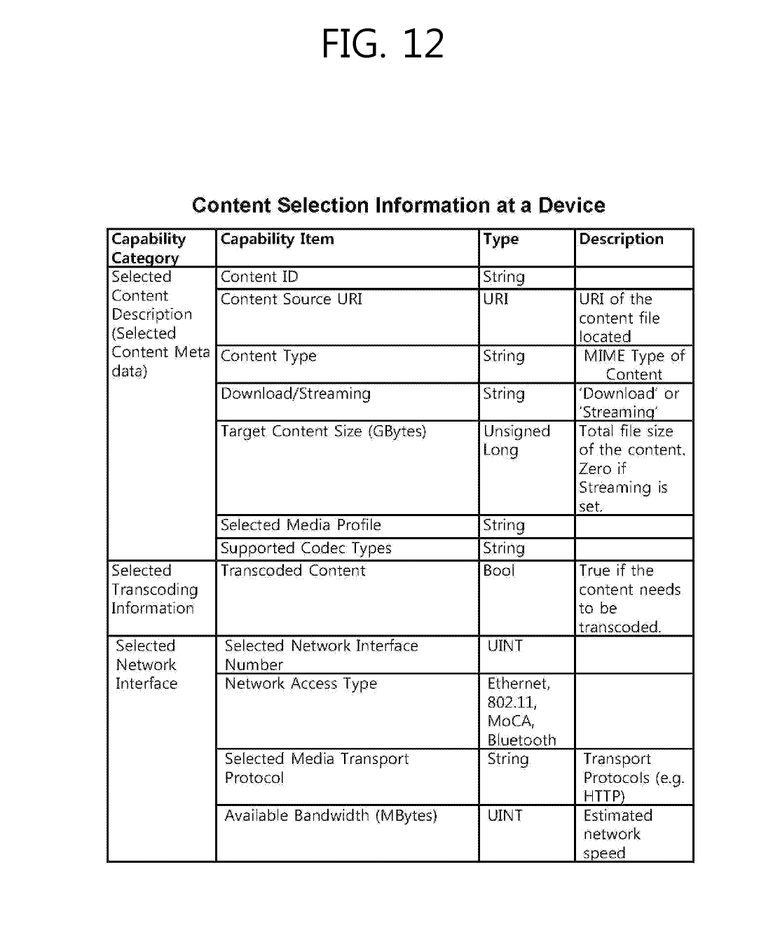

FIG. 12 is a table showing content selection information stored and managed by a client device.

As shown in FIG. 12, content selection information stored and managed by a client device can be classified into three categories, for example, a selected content description, selected transcoding information, and a selected network interface.

The selected content description may be content metadata associated with selected content. The selected content description may include a content ID for identifying selected content, a content source URI indicative of information about the position and ID of a source from which selected content can be received, a content type indicative of the MIME type of selected content, downloading/streaming for selecting downloading and streaming, a target content size indicative of the size of target content, a selected media profile indicative of information about the media profile of selected content, a supported codec type indicative of a supported codec type, etc. The target content size may be a zero value if downloading/streaming is set to streaming.

The selected transcoding information may include transcoded content indicating whether or not content has been transcoded. If content needs to be transcoded, a value of the transcoded content may be set to true.

The selected network interface may include a selected network interface number indicative of the number of selected network interfaces, a network access type, a selected media transport protocol, an available bandwidth limit, etc.

Although the embodiments of the present invention have been described above, those skilled in the art will appreciate that the present invention may be modified in various ways without departing from the spirit and scope of the present invention defined in the appended claims. Accordingly, a possible change of the embodiments of the present invention will not depart from the technology of the present invention.

What is claimed is:

1. A method for receiving content, performed by a client device, comprising:
acquiring a plurality of source access information by searching a plurality of sources storing selected content;
generating at least one queue request including the plurality of source access information;
selecting any one of source access information among the plurality of source access information based on at least one queue request; and
receiving the selected content by using the selected source access information.

2. The method of claim 1, wherein at least one queue request includes
a first queue request including first source access information and second source access information.

3. The method of claim 2, wherein the selecting of any one of source access information among the plurality of source access information includes
selecting any one of the first source access information and the second source access information, based on any one of transmission bandwidth information corresponding to each source access information and a selection signal input from a user interface.

4. The method of claim 2, further comprising:
Transmitting, to a first source and a second source, a content download request of requesting to transmit the content by using the first source access information and the second access information;
downloading the content from the first source and the second source for a predetermined time, respectively; and
estimating a transmission bandwidth corresponding to each of the first source access information and the second source access information, by analyzing the content download for the predetermined time.

5. The method of claim 4, wherein the selecting any one of source access information among the plurality of source access information includes
selecting source access information having a larger transmission bandwidth, based on transmission bandwidth information corresponding to the first source access information and transmission bandwidth information corresponding to the second source access information.

6. The method of claim 1, wherein at least one queue request includes
a first queue request including the first source access information and a first queue request priority; and
a second queue request including the second source access information and a second queue request priority.

7. The method of claim 6, further comprising:
setting the first queue request priority and the second queue request priority, based on any one of the transmission bandwidth information corresponding to each source access information and priority information input from a user interface.

8. The method of claim 6, further comprising:
transmitting a content download request of requesting to transmit the content to a first source and a second source by using the first source access information and the second access information;
downloading the content from the first source and the second source for a predetermined time, respectively;
estimating a transmission bandwidth corresponding to each of the first source access information and the second source access information, by analyzing the content download for the predetermined time; and
setting the first queue request priority and the second queue request priority according to the transmission bandwidth corresponding to the first source access information and the transmission bandwidth corresponding to the second source access information.

9. The method of claim 6, wherein the selecting of any one of source access information among the plurality of source access information includes
transiting a queue request having a high priority of the first queue request and the second queue request to an active status; and
transiting a queue request having a low priority of the first queue request and the second queue request to any one of a blocked state, a standby state, and a suspended state.

10. The method of claim 9, further comprising:
using the source access information included in the queue request transited to the active state, in order to download the selected content.

11. The method of claim 1, wherein the plurality of source access information includes at least any one of a universal resource identifier (URI) for accessing to the content stored in a device of a user domain, and a universal resource identifier for accessing to the content stored in a device of a server domain.

12. An apparatus for receiving content, comprising:
an application configured to acquire a plurality of source access information by searching a plurality of sources storing a selected content and generate at least one queue request including the plurality of source access information; and
a queue and policy engine configured to select one source access information among the plurality of source access information based on at least one queue request and receive the selected content by using the selected source access information.

13. The apparatus of claim 12, wherein at least one queue request includes
a first queue request including first source access information and second source access information.

14. The apparatus of claim 13, wherein the queue and policy engine
selects any one of the first source access information and the second source access information, based on any one of transmission bandwidth information corresponding to each source access information and a selection signal input from a user interface.

15. The apparatus of claim 12, wherein at least one queue request includes
a first queue request including the source access information and a first queue request priority; and
a second queue request including the second source access information and a second queue request priority.

16. The apparatus of claim 15, wherein the application
sets the first queue request priority and the second queue request priority, based on any one of the transmission bandwidth information corresponding to each source access information and priority information input from a user interface.

17. The apparatus of claim 15, wherein the queue and policy engine
transits a queue request having a high priority of the first queue request and the second queue request to an active status, and transits a queue request having a low priority of the first queue request and the second queue request to any one of a blocked state, a standby state, and a suspended state.
